(19) United States
(12) Patent Application Publication
(10) Pub. No.: US 2025/0245563 A1
(43) Pub. Date: Jul. 31, 2025

(54) SYSTEM AND METHOD FOR TRAINING MACHINE LEARNING MODEL WITH GEOGRAPHICAL LOCATION

(71) Applicant: GRABTAXI HOLDINGS PTE. LTD., Singapore (SG)

(72) Inventors: Donghan HE, Singapore (SG); Xulang WAN, Singapore (SG); Ruike ZHANG, Singapore (SG); Renrong WENG, Singapore (SG)

(21) Appl. No.: 18/707,282

(22) PCT Filed: Nov. 21, 2022
(86) PCT No.: PCT/SG2022/050844

§ 371 Date: May 3, 2024

(30) Foreign Application Priority Data
Nov. 24, 2021 (SG) 10202113067P

(51) Int. Cl. G06N 20/00

(52) U.S. Cl. CPC G06N 20/00

(57) ABSTRACT

According to various embodiments, a system for training a machine learning model with a geographical location is provided. The system comprises: an input device configured to obtain a geolocation index for the geographical location; and a processor configured to train the machine learning model in relation to the geographical location, wherein the processor is further configured to split the geolocation index into a plurality of geolocation indexes each having different scales, embed each of the plurality of geolocation indexes to obtain a plurality of values relating to latitude and longitude for the plurality of geolocation indexes respectively, aggregate the plurality of values to obtain the representation value of the geographical location, and train the machine learning model using the representation value of the geographical location.

### TECHNICAL FIELD

Various embodiments relate to a system and a method for training a machine learning model with geographical location.

### BACKGROUND

Obtaining accurate road information of real world may be crucial in many industries providing location-based services. Specifically, in transportation services, ride-hailing services and/or delivery services, representing trips using the accurate road information may allow to provide more precise information.

For example, with the advent of a machine learning model applied to the transportation services, the ride-hailing services and/or the delivery services, representing the trips using the accurate road information may facilitate performing downstream tasks such as regression problems or classification problems, or used as states for reinforcement learning algorithms. As an example, in an Auto-Based Pricing (ABP) project, the reinforcement learning algorithms may be adopted to learn price elasticity of demand, to adaptively predict users' behaviour against the price, and to optimally perform tasks with high efficiency.

However, it may be challenging to represent the trips, since typically, in real applications, many geographical locations may not be present in a dataset but might be present in future. Conventional solutions which may extrapolate to unseen data points may not typically show great performance on some important tasks.

For example, a solution (hereinafter, referred to as a “first solution”) to directly learn embeddings for a level of granularity may show promising results on seen data points, but extrapolate poorly to unseen data points. As another example, another solution (hereinafter, referred to as a “second solution”) to simply use latitude and longitude as representations of geolocation's features, in place of the embeddings of the first solution, may extrapolate to unseen data points naturally, but be insufficient as a good feature for the downstream tasks.

The lack of a solution that may both be trained in an intelligent way and also extrapolate to unseen data points may lead the trained machine learning model not to well generalise other trips. Such trained machine learning model may not well perform the downstream tasks, for example, giving reinforcement learning agent competent states, book-through-rate prediction, and so on.

### SUMMARY

According to various embodiments, a system for training a machine learning model with a geographical location is provided. The system comprises: an input device configured to obtain a geolocation index for the geographical location; and a processor configured to train the machine learning model in relation to the geographical location, wherein the processor is further configured to split the geolocation index into a plurality of geolocation indexes each having different scales, embed each of the plurality of geolocation indexes to obtain a plurality of values relating to latitude and longitude for the plurality of geolocation indexes respectively, aggregate the plurality of values to obtain a representation value of the geographical location, and train the machine learning model using the representation value of the geographical location.

In some embodiments, the plurality of geolocation indexes each having different scales includes the obtained geolocation index and one or more coarser level geolocation indexes than the obtained geolocation index.

In some embodiments, the geolocation index includes a geohash.

In some embodiments, where the geolocation index is the geohash, the processor is configured to gradually remove one or more characters from an end of the geohash to obtain one or more geohashes each having different scales.

In some embodiments, number of a plurality of geohashes each having different scales is same as length of the geohash.

In some embodiments, the processor is configured to embed the each of the plurality of geolocation indexes by latitude-longitude embedding, and geohash embedding for naive embedding.

In some embodiments, the processor is configured to calculate an average of the plurality of values to obtain the representation value of the geographical location.

In some embodiments, the processor is further configured to train the machine learning model based on a set of observed data points, and embed the representation value of the geographical location into the machine learning model.

According to various embodiments, there is a method of training a machine learning model with a geographical location comprising: obtaining a geolocation index for the geographical location; splitting the geolocation index into a plurality of geolocation indexes each having different scales; embedding each of the plurality of geolocation indexes to obtain a plurality of values relating to latitude and longitude for the plurality of geolocation indexes respectively; aggregating the plurality of values to obtain a representation value of the geographical location; and training the machine learning model using the representation value of the geographical location.

In some embodiments, the plurality of geolocation indexes each having different scales includes the obtained geolocation index and one or more coarser level geolocation indexes than the obtained geolocation index.

In some embodiments, the geolocation index includes a geohash.

In some embodiments, where the geolocation index is the geohash, the method further includes: gradually removing one or more characters from an end of the geohash to obtain one or more geohashes each having different scales.

In some embodiments, number of a plurality of geohashes each having different scales is same as length of the geohash.

In some embodiments, embedding each of the plurality of geolocation indexes includes: embedding the each of the plurality of geolocation indexes by latitude-longitude embedding, and geohash embedding for naive embedding.

In some embodiments, aggregating the plurality of values includes: calculating an average of the plurality of values to obtain the representation value of the geographical location.

In some embodiments, training the machine learning model includes: training the machine learning model based on a set of observed data points; and embedding the representation value of the geographical location into the machine learning model.

According to various embodiments, a data processing apparatus configured to perform the method of any one of the above embodiments is provided.

According to various embodiments, a computer program element comprising program instructions, which, when executed by one or more processors, cause the one or more processors to perform the method of any one of the above embodiments is provided.

According to various embodiments, a computer-readable medium comprising program instructions, which, when executed by one or more processors, cause the one or more processors to perform the method of any one of the above embodiments is provided. The computer-readable medium may include a non-transitory computer-readable medium.

### BRIEF DESCRIPTION OF THE DRAWINGS

The invention will be better understood with reference to the detailed description when considered in conjunction with the non-limiting examples and the accompanying drawings, in which:

FIG. 1 shows a block diagram for a system for training a machine learning model with a geographical location according to various embodiments.

FIG. 2 shows an exemplary flowchart for a method of training a machine learning model with a geographical location according to various embodiments.

FIGS. 3 and 4 show exemplary flowcharts for a method of training a machine learning model with a geographical location according to various embodiments.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of a system and a method are analogously valid for the other system and method. Similarly, embodiments described in the context of a system are analogously valid for a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

In the following, embodiments will be described in detail.

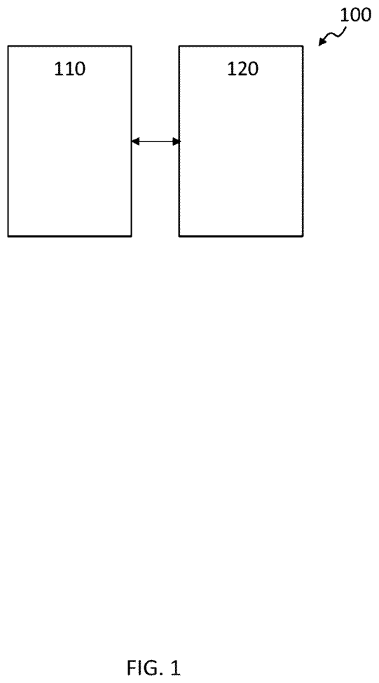

FIG. 1 shows a block diagram for a system 100 for training a machine learning model with a geographical location according to various embodiments. In some embodiments, the system 100 may be referred to as a hierarchical embedding system.

The system 100 may be a set of interacting elements. The elements may be, by way of example and not of limitation, one or more mechanical components, one or more electrical components, and/or one or more instructions, for example, encoded in a storage media.

As shown in FIG. 1, the system 100 may include an input device 110 and a processor 120. In some embodiments, the input device 110 and the processor 120 may be mounted on the same device. In some other embodiments, the input device 110 and the processor 120 may be mounted on different devices. The input device 110 and the processor 120 may be capable of data communication.

The input device 110 may obtain a geolocation index for a geographical location. In some embodiments, the geolocation index may be an index representing the geographical location. In some embodiments, the geolocation index may be referred to as a spatial index. As an example, the geolocation index may be a string of letters and digits. In some embodiments, the geolocation index includes a geohash. The geohash may be a geocode system which may encode the geographical location into a short string of letters and digits. The geohash may be a hierarchical spatial data structure and provide properties like arbitrary precision. For example, as characters are gradually removed from the end of the geohash to reduce its size, precision may gradually be lost. It may be appreciated that the geolocation index is not limited to the geohash. In some other embodiments, the geolocation index may include an H3 (Hexagonal Hierarchical Spatial Index).

The processor 120 may include a microprocessor, an analogue circuit, a digital circuit, a mixed-signal circuit, a logic circuit, an integrated circuit, a Central Processing Unit (CPU), a Graphics Processing Unit (GPU), a Digital Signal Processor (DSP), a Field Programmable Gate Array (FPGA), an Application Specific Integrated Circuit (ASIC), etc., or any combination thereof. Any other kind of implementation of the respective functions, which will be described below in further detail, may also be understood as the processor 120.

In accordance with various embodiments, the processor 120 may train the machine learning model in relation to the geographical location. The machine learning model may relate to trip be used for various applications, including transportation services, ride-hailing services and/or delivery services, but not be limited thereto. In some embodiments, input data for the machine learning model may involve trip data. The processor 120 may input the trip data into the machine learning model for training the machine learning model. The trained machine learning model may generalise to other trips.

In accordance with various embodiments, the processor 120 may obtain a representation value of the geographical location using the geolocation index, for example, the geohash obtained by the input device 110, to better train the machine learning model.

In some embodiments, the processor 120 may split the geolocation index into a plurality of geolocation indexes each having different scales. In some embodiments, the plurality of geolocation indexes each having different scales may include the obtained geolocation index, and one or more coarser level of geolocation indexes than the obtained geolocation index.

In some embodiments, where the geolocation index is the geohash, the processor 120 may split the geohash obtained by the input device 110 into a plurality of geohashes each having different scales. In some embodiments, the processor 120 may gradually remove characters from the end of the obtained geohash, to obtain one or more geohashes having coarser level than the obtained geohash. In this manner, the processor 120 may parse the obtained geohash to the plurality of geohashes having from the finest level desired to the coarsest level desired.

In some embodiments, the number of the plurality of geohashes each having different scales may be the same as length of the geohash. In some embodiments, the finest level desired and/or the coarsest level desired may be determined by a user and/or the processor 120. For example, the finest level desired and/or the coarsest level desired may be determined by the user based on at least one factor. The factor may include, but not be limited to, a space needed for storing (for example, depending on a country) and difficulty of a task the embedding is intended for. For example, the finest level desired may be a level of geohash 7, but not be limited thereto. As an example, the coarsest level desired may be a level of geohash 1, but not be limited thereto.

For example, if the obtained geohash is geohash 7, the finest level desired is a level of geohash 7, and the coarsest level desired is a level of geohash 1, the processor 120 may split the geohash 7 into seven (7) geohashes (i.e. from geohash 7 which has the finest level to geohash 1 which has the coarsest level). As another example, if the obtained geohash is geohash 7, the finest level desired is a level of geohash 7, and the coarsest level desired is a level of geohash 3, the processor 120 may split the geohash 7 into five (5) geohashes (i.e. from geohash 7 which has the finest level to geohash 3 which has the coarsest level). As another example, if the obtained geohash is geohash 7, the finest level desired is a level of geohash 5, and the coarsest level desired is a level of geohash 1, the processor 120 may split the geohash 7 into five (5) geohashes (i.e. from geohash 5 which has the finest level to geohash 1 which has the coarsest level). As another example, if the obtained geohash is geohash 7, the finest level desired is a level of geohash 5, and the coarsest level desired is a level of geohash 3, the processor 120 may split the geohash 7 into three (3) geohashes (i.e. from geohash 5 which has the finest level to geohash 3 which has the coarsest level).

In some embodiments, the processor 120 may embed each of the plurality of geolocation indexes to obtain a plurality of values relating to latitude and longitude for the plurality of geolocation indexes respectively. In some embodiments, the processor 120 may embed the each of the plurality of geolocation indexes by latitude-longitude (lat-lon) embedding, and geohash embedding for naive embedding. In some embodiments, the lat-lon embedding may perform transformations (for example, sine and cosine functions) of latitude and longitude (i.e. mostly geographical information). In some embodiments, the naive embedding may be a hierarchical embedding with the finest level. The lat-lon embedding and the naive embedding may be used as a comparison (i.e. baseline) to the hierarchical embedding. In some embodiments, the naive embedding may be to simply give each geolocation index, for example, each geohash, a unique embedding vector.

In some embodiments, where the geolocation index is the geohash, the processor 120 may embed each of the plurality of geohashes, from geohash 7 which has the finest level to geohash 1 which has the coarsest level, to obtain the plurality of values for the plurality of geohashes respectively. Each of the plurality of values may be latitude and longitude for the lat-lon embedding, and geohash embedding for naive embedding.

In some embodiments, the processor 120 may aggregate the plurality of values to obtain the representation value of the geographical location. In some embodiments, the processor 120 may calculate an average of the plurality of values to obtain the representation value of the geographical location.

In some embodiments, where the geolocation index is the geohash, the processor 120 may aggregate the plurality of values by calculating the average of the plurality of values. In some embodiments, the representation value of the geohash may be the average of the plurality of values for the plurality of geohashes respectively.

In some embodiments, the system 100 may further include a memory (not shown). The memory may be used by the processor 120 to permanently or temporarily store, for example, the geolocation index and/or the plurality of geolocation indexes each having different scales to be processed to obtain the representation value of the geographical location. The memory may store data to train the machine model (as will be described in further detail below). The memory may include, but not be limited to, a cloud memory, a server memory, and a physical storage, for example a RAM (random-access memory), an HDD (hard disk drive), an SSD (solid-state drive), others, or any combinations thereof.

In some embodiments, the processor 120 may decompose the representation value of the obtained geohash N, for example geohash 7, as the combination of itself and coarser level of geohashes, for example a level of geohash 1 (gh1). In some embodiments, the processor 120 may obtain the representation value of the geographical location based on a mathematical equation as follows:

rep(ĝ)=agg(rep(gh7), . . . ,rep(gh1))

where agg is an aggregation function which may go from a simple aggregation scheme in which parameters and training are not involved, for example a concatenation aggregation scheme and/or a summation aggregation scheme, to a complicated aggregation scheme such as a neural network-based aggregation scheme which may or may not need the training depending on the performance, repo is a representation value of the geographical location which is latitude and longitude for the lat-lon embedding, and the geohash embedding for the naive embedding, gh7 is the finest geohash which is desired (i.e. geohash 7, if the desired finest level is a level of geohash 7), gh1 is the coarsest geohash which is desired (i.e. geohash 1, if the desired coarsest level is a level of geohash 1), and § is a geolocation where the system 100 is trying to learn the representation value. In some embodiments, the § may be the finest scale that the user may observe the data in. The § may be gh7, but not be limited thereto.

In some embodiments, in the concatenation aggregation scheme, each embedding (across different geohash granularity levels) may be concatenated to form a representation value. In the summation aggregation scheme, each embedding (across different geohash granularity levels) may be summed element-wise to form a representation value. In an averaging aggregation scheme, each embedding (across different geohash granularity levels) may be summed element-wise, and then divided by the number of embedded geohashes to form a representation value. In the neural network-based aggregation scheme, each embedding (across different geohash granularity levels) may be passed through a neural network to form a representation value.

In some embodiments, the processor 120 may backtrack up to geohash 4, if geohash 4 may be present in the dataset for the area, for example city, of interest. It may be appreciated that the scope of backtrack may not be limited to the geohash 4, and it may vary depending on the area of interest and/or a type of applications for use in the area.

In some embodiments, it may be appreciated that the decomposition is not limited to the geohash, and may extend to other geolocation indexing systems such as the H3. A general form of the decomposition may be referred to as H-DoG (Hierarchical Decomposition of Geolocations). In some embodiments, the processor 120 may obtain the representation value of the geographical location for the geolocation indexing systems, based on a mathematical equation as follows:

rep(ĝ)=agg(rep(g_{coarsest}:ĝ∈g_{Coarsest}), . . . ,rep(g_{Finest}:ĝ∈g_{Finest}))

where agg is an aggregation function which may go from a simple aggregation scheme in which parameters and training are not involved, for example a concatenation aggregation scheme and/or a summation aggregation scheme, to a complicated aggregation scheme such as a neural network-based aggregation scheme which may or may not need the training depending on the performance, rep( ) is a representation value of the geographical location which is latitude and longitude for the lat-lon embedding, g_{Finest} is the finest geolocation index which is desired, g_{Coarsest} is the coarsest geolocation index which is desired, and ĝ is a geolocation that the system 100 is trying to learn the representation value. The E operator may be generalised beyond a simple geographical inclusion. In some embodiments, rep( ) may be used with other geolocation indexing systems such as the H3.

In some embodiments, the processor 120 may train the machine learning model using the representation value of the geographical location. In this manner, the system 100 in accordance with various embodiments may provide the better trained machine learning model which may well generalise to other trips.

Although not shown, in some embodiments, the processor 120 may train the machine learning model based on a set of observed data points, and embed the representation value of the geographical location into the machine learning model.

Advantageously, the system 100 in accordance with various embodiments may incur low extra storage costs, as the number of coarser level of representations needed to be stored may shrink geometrically. The system 100 may require the same order of magnitude of storage as the naive embedding method. In addition, the system 100 may highly be modularised, as the system 100 may be plugged into existing tasks where geolocations are used as a feature, and used in-place as such. The system 100 may extrapolate to unseen data points by backtracking to the coarser level of representations, and aggregate from the coarser level of representations to generate granular representations by combining the coarser level of representations.

In some embodiments, the system 100 may be used for trip representation for the Auto-Based Pricing (ABP) project, for examples tasks used as a state for an agent to learn an action with and book through a rate prediction. By using the system 100 for the ABP project, the agent may learn better with the hierarchical embedding in the context of adding prices to trips, and learn a good book-through-rate model. It may be appreciated that the system 100 may be used for various applications, including transportation services, ride-hailing services and/or delivery services, but not be limited thereto.

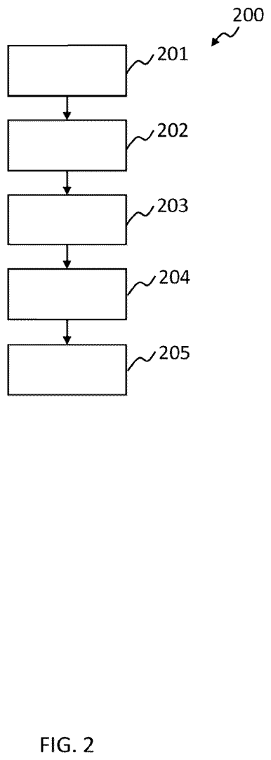

FIG. 2 shows an exemplary flowchart for a method 200 of training a machine learning model with a geographical location according to various embodiments. According to various embodiments, the method 200 of training the machine learning model with the geographical location may be provided.

In some embodiments, the method 200 may include a step 201 of obtaining a geolocation index for a geographical location. For example, the geolocation index may include a geohash consisting of a string of letters and digits.

In some embodiments, the method 200 may include a step 202 of splitting the geolocation index into a plurality of geolocation indexes each having different scales. For example, the geohash may be split into a plurality of geohashes each having different scales. As an example, one or more characters may be gradually removed from the end of the geohash to obtain one or more geohashes each having different scales.

In some embodiments, the method 200 may include a step 203 of embedding each of the plurality of geolocation indexes to obtain a plurality of values relating to latitude and longitude for the plurality of geolocation indexes respectively.

In some embodiments, the method 200 may include a step 204 of aggregating the plurality of values to obtain a representation value of the geographical location. For example, an average of the plurality of values for the plurality of geohashes respectively may be calculated to obtain the representation value of the geographical location.

In some embodiments, the method 200 may include a step 205 of training the machine learning model using the representation value of the geographical location. In this manner, the method 200 in accordance with various embodiments may provide the better trained machine learning model which may well generalise to other trips.

In some embodiments, the method 200 may be referred to as a hierarchical embedding method. In accordance with various embodiments, the method 200 may extrapolate to unseen data points, and may perform downstream tasks on both unseen data points and seen data points. In addition, in some embodiments, the method 200 may be highly correlated with trip information. In addition, in some embodiments, the method 200 may be trainable.

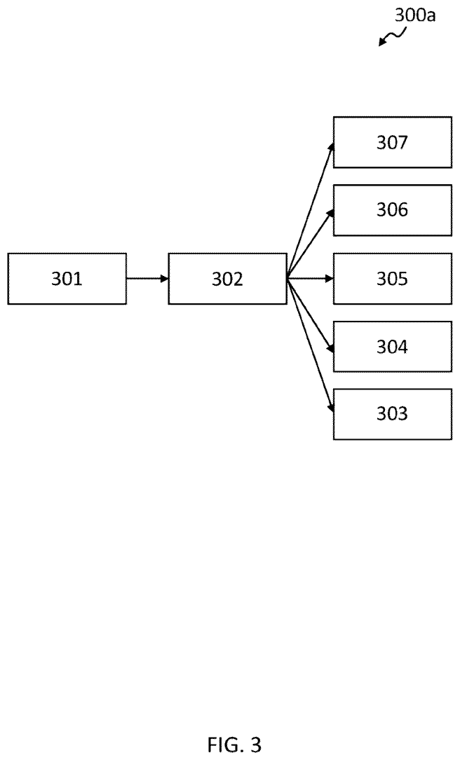

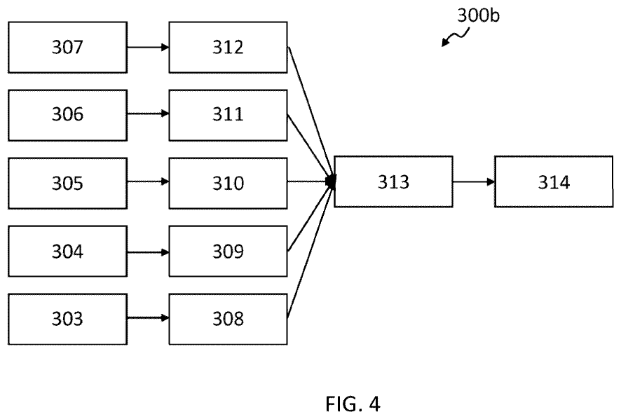

FIGS. 3 and 4 show exemplary flowcharts for a method 300 of training a machine learning model with a geographical location according to various embodiments. According to various embodiments, the method 300 of training the machine learning model with the geographical location may be provided. In some embodiments, the method 300 may be referred to as a hierarchical embedding method.

In some embodiments, the method 300 may use off-the-shelf libraries which may be used to build the hierarchical embedding in an end-to-end open source platform for machine learning, for example, Tensorflow. The hierarchical embedding may be built using the platform, for example, the Tensorflow.

As shown in FIGS. 3 and 4, the method 300 may include two parts 300a, 300b (hereinafter, referred to as a “first part 300a” and a “second part 300b”). As shown in FIG. 3, the first part 300a of the method 300 may relate to parsing an inputted geolocation index to a plurality of geolocation indexes each having different scales from the finest level desired to the coarsest level desired. As shown in FIG. 4, the second part 300b of the method 300 may relate to embedding the plurality of geolocation indexes and aggregating the embedded geolocation indexes.

As shown in FIG. 3, in some embodiments, the method 300 may include a step 301 of receiving an inputted geolocation index, for example, a geohash (for example, “WE78A45” consisting of string of letters and digits of length seven (7)) for a geographical location. As described above with FIG. 1, the geohash may be a geocode system which may encode the geographical location into a short string of letters and digits. It may be appreciated that any other types of geolocation index may be inputted. For example, an H3 (Hexagonal Hierarchical Spatial Index) may be used as the geolocation index.

In some embodiments, the method 300 may include a step 302 of splitting the inputted geohash into a plurality of geohashes each having different scales from the finest level desired to the coarsest level desired. In some embodiments, although not shown in FIG. 3, the number of the plurality of geohashes each having different scales may be the same as length of the inputted geohash (for example, seven (7)), and thus the finest level desired may be a level of geohash 7 and the coarsest level desired may be a level of geohash 1. In some other embodiments, the number of the plurality of geohashes each having different scales may be different from the length of the inputted geohash, and thus the finest level desired may not be the level of geohash 7 and the coarsest level desired may not be the level of geohash 1. For example, as shown in FIG. 3, the finest level desired may be a level of geohash 7 and the coarsest level desired may be a level of geohash 3.

In some embodiments, as shown in steps 303 to 307 of FIG. 3, where the finest level desired may be a level of geohash 7 and the coarsest level desired is the level of geohash 3, the inputted geohash (for example, “WE78A45”) may be split into five (5) geohashes (i.e. from geohash 7 which has the finest level to geohash 3 which has the coarsest level). To split the inputted geohash into the plurality of geohashes, for example, five (5) geohashes, one or more characters may be gradually removed from the end of the geohash (for example, “WE78A45”). As the characters may be gradually removed from the end of the geohash (for example, “WE78A45”), a size of the geohash may gradually be reduced and precision may gradually be lost.

In some embodiments, the method 300 may include a step 303 of obtaining the inputted geohash (for example, “WE78A45”) (hereinafter, referred to as a “geohash 7”). The geohash 7 may have the finest level among the plurality of geohashes.

In some embodiments, the method 300 may include a step 304 of obtaining a coarser geohash (for example, “WE78A4”)(hereinafter, referred to as a “geohash 6”) than the geohash 7, by reducing one (1) character (for example, “5”) from the end of the geohash 7 (for example, “WE78A45”).

In some embodiments, the method 300 may include a step 305 of obtaining a coarser geohash (for example, “WE78A”) (hereinafter, referred to as a “geohash 5”) than the geohash 6 and the geohash 7, by reducing two (2) characters (for example, “45”) from the end of the geohash 7 (for example, “WE78A45”).

In some embodiments, the method 300 may include a step 306 of obtaining a coarser geohash (for example, “WE78”) (hereinafter, referred to as a “geohash 4”) than the geohash 5, the geohash 6 and the geohash 7, by reducing three (3) characters (for example, “A45”) from the end of the geohash 7 (for example, “WE78A45”).

In some embodiments, the method 300 may include a step 307 of obtaining a coarser geohash (for example, “WE7”) (hereinafter, referred to as a “geohash 3”) than the geohash 4, the geohash 5, the geohash 6 and the geohash 7, by reducing four (4) characters (for example, “8A45”) from the end of the geohash 7 (for example, “WE78A45”). The geohash 3 may have the coarsest level desired, among the plurality of geohashes.

As shown in FIG. 4, in some embodiments, at the step 303, the geohash 7 (for example, “WE78A45”) may be obtained. In some embodiments, the method 300 may include a step 308 of embedding the geohash 7 to obtain a value (hereinafter, referred to as a “first value”) relating to latitude and longitude for the geohash 7. The embedding of the step 308 may be performed on the finest desired scale.

In some embodiments, at the step 304, the geohash 6 (for example, “WE78A4”) may be obtained. In some embodiments, the method 300 may include a step 309 of embedding the geohash 6 to obtain a value (hereinafter, referred to as a “second value”) relating to latitude and longitude for the geohash 6.

In some embodiments, at the step 305, the geohash 5 (for example, “WE78A”) may be obtained. In some embodiments, the method 300 may include a step 310 of embedding the geohash 5 to obtain a value (hereinafter, referred to as a “third value”) relating to latitude and longitude for the geohash 5.

In some embodiments, at the step 306, the geohash 4 (for example, “WE78”) may be obtained. In some embodiments, the method 300 may include a step 311 of embedding the geohash 4 to obtain a value (hereinafter, referred to as a “fourth value”) relating to latitude and longitude for the geohash 4.

In some embodiments, at the step 307, the geohash 3 (for example, “WE7”) may be obtained. In some embodiments, the method 300 may include a step 312 of embedding the geohash 3 to obtain a value (hereinafter, referred to as a “fifth value”) relating to latitude and longitude for the geohash 3. The embedding of the step 312 may be performed on the coarsest desired scale.

In some embodiments, the method 300 may include a step 313 of aggregating the plurality of values (i.e. the first value, the second value, the third value, the fourth value and the fifth value). In some embodiments, at the step 313, an average of the plurality of values may be calculated.

In some embodiments, the method 300 may include a step 314 of obtaining a representation value of the geographical location. In some embodiments, the representation value may be the average of the plurality of values. In some embodiments, the representation value may be in the form of a value of a d-dimensional vector, for example, in the form of “[−0.5, 2.3, . . . , −0.13]”.

Although not shown, in some embodiments, the method 300 may further include a step of training the machine learning model using the representation value of the geographical location. In this manner, the method 300 in accordance with various embodiments may provide the better trained machine learning model which may well generalise to other trips. Although not shown, in some embodiments, the method 300 may further include steps of training the machine learning model based on a set of observed data points, and embedding the representation value of the geographical location into the machine learning model.

The hierarchical embedding system and method in accordance with various embodiments may be used in various scenarios and/or applications where missing data points are present. For example, the hierarchical embedding may be used for a task of predicting a trip booking decision and/or a task of predicting a substitute effect of merchant level and demand level in a next step for a food surge problem. It may be appreciated that the hierarchical embedding may be used for other types of tasks.

In some embodiments, the hierarchical embedding may be used for the task of predicting the trip booking decision, where after training, some data points may be missing in test datasets. The machine learning model (for example, the trip booking decision prediction model) may be trained based on a set of observed data points, and the representation value of the geographical location may be embedded into the machine learning model. Thereafter, the machine learning model may be tested to see how good the machine learning model is on the test datasets where some data points are not observed previously. The machine learning model trained with the hierarchical embedding may consistently outperform baseline models on seen data points, data points which come from observed geohash 6 data points but unseen geohash 7 data points, and data points which come from observed geohash 5 data points but unseen geohash 6 data points (and unseen geohash 7 data points). For example, the baseline models may include a both book-through rate model trained with the lat-lon embedding and a book-through rate model trained with the naive embedding.

In some other embodiments, the hierarchical embedding may be used for the task of predicting the substitute effect of merchant level and demand level in the next step for the food surge problem. This may be a crucial interaction effect that may be needed to be modelled to output optimal pricing. It may be hypothesized that the hierarchical embedding may capture an interaction between merchants, because the hierarchical embedding may contain both finer level of information representing individual level information (i.e. detailed level or fine-grained level information), and coarser level of information representing commonalities for the merchants in a general area. Moreover, due to hypothetically being able to capture individual level information, the hierarchical embedding may also capture the substitute effect of the merchants that may not geographically be close better.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A system for training a machine learning model with a geographical location comprising:
an input device configured to obtain a geolocation index for the geographical location; and
a processor configured to train the machine learning model in relation to the geographical location,
wherein the processor is further configured to split the geolocation index into a plurality of geolocation indexes each having different scales, embed each of the plurality of geolocation indexes to obtain a plurality of values relating to latitude and longitude for the plurality of geolocation indexes respectively, aggregate the plurality of values to obtain a representation value of the geographical location, and train the machine learning model using the representation value of the geographical location.

2. The system according to claim 1, wherein the plurality of geolocation indexes each having different scales includes the obtained geolocation index and one or more coarser level geolocation indexes than the obtained geolocation index.

3. The system according to claim 1, wherein the geolocation index includes a geohash.

4. The system according to claim 3, wherein where the geolocation index is the geohash, the processor is configured to gradually remove one or more characters from an end of the geohash to obtain one or more geohashes each having different scales.

5. The system according to claim 4, wherein number of a plurality of geohashes each having different scales is same as a length of the geohash.

6. The system according to claim 3, wherein the processor is configured to embed the each of the plurality of geolocation indexes by latitude-longitude embedding, and geohash embedding for naive embedding.

7. The system according to claim 1, wherein the processor is configured to calculate an average of the plurality of values to obtain the representation value of the geographical location.

8. The system according to claim 1, wherein the processor is further configured to train the machine learning model based on a set of observed data points, and embed the representation value of the geographical location into the machine learning model.

9. A method of training a machine learning model with a geographical location comprising:
obtaining a geolocation index for the geographical location;
splitting the geolocation index into a plurality of geolocation indexes each having different scales;
embedding each of the plurality of geolocation indexes to obtain a plurality of values relating to latitude and longitude for the plurality of geolocation indexes respectively;
aggregating the plurality of values to obtain a representation value of the geographical location; and
training the machine learning model using the representation value of the geographical location.

10. The method according to claim 9, wherein the plurality of geolocation indexes each having different scales includes the obtained geolocation index and one or more coarser level geolocation indexes than the obtained geolocation index.

11. The method according to claim 9, wherein the geolocation index includes a geohash.

12. The method according to claim 11, wherein where the geolocation index is the geohash, the method further comprises: gradually removing one or more characters from an end of the geohash to obtain one or more geohashes each having different scales.

13. The method according to claim 12, wherein number of a plurality of geohashes each having different scales is same as a length of the geohash.

14. The method according to claim 11, wherein embedding each of the plurality of geolocation indexes comprises: embedding the each of the plurality of geolocation indexes by latitude-longitude embedding, and geohash embedding for naive embedding.

15. The method according to claim 9, wherein aggregating the plurality of values comprises: calculating an average of the plurality of values to obtain the representation value of the geographical location.

16. The method according to claim 9, wherein training the machine learning model comprises:
training the machine learning model based on a set of observed data points; and
embedding the representation value of the geographical location into the machine learning model.

17. A data processing apparatus configured to perform the method of claim 9.

18. A computer program element comprising program instructions, which, when executed by one or more processors, cause the one or more processors to perform the method of claim 9.
